(19) United States
(12) Patent Application Publication
(10) Pub. No.: US 2025/0178404 A1
(43) Pub. Date: Jun. 5, 2025

(54) OPTIMIZATION OF THE MANAGEMENT OF A MOTOR VEHICLE HEAT PUMP

(71) Applicant: VALEO SYSTEMES THERMIQUES, La Verriere (FR)

(72) Inventors: Bertrand GESSIER, La Verriere (FR); Richard COTTET, La Verriere (FR); Benjamin PLA MORENO, La Verriere (FR)

(73) Assignee: VALEO SYSTEMES THERMIQUES, La Verriere (FR)

(21) Appl. No.: 18/727,488

(22) PCT Filed: Jan. 9, 2023
(86) PCT No.: PCT/EP2023/050275

§ 371 Date: Jul. 9, 2024

(30) Foreign Application Priority Data
Jan. 9, 2022 (FR) 2200130

(51) Int. Cl. B60H 1/00; B60R 16/033

(52) U.S. Cl. CPC B60H 1/0073; B60H 1/00771; B60R 16/033

(57) ABSTRACT

The invention relates to a method for the thermal management of a vehicle of the type comprising a heat pump, for heating and/or cooling the traction system of the vehicle, the electrical power storage device and the passenger compartment of the vehicle. The thermal management method comprises: —a computation sub-method for so-called long-term supervision over at least a plurality of long journey sections, and the supervision sub-method carries out a simplified optimization computation of the heat losses of all devices over said plurality of long journey sections, minimizing the sum of the heat losses of the electrical power storage device, —a computation sub-method for so-called short-term control over short journey sections, which are shorter than said long journey sections, and the control sub-method carries out an optimization computation of the heat losses over said plurality of short journey sections.

### TECHNICAL FIELD

The field of the present invention relates to vehicles comprising a drive system of the vehicle, an electrical energy storage device, and a heat pump heating and/or cooling device, to heat and/or cool the drive system of the vehicle, the electrical energy storage device, and the passenger compartment of the vehicle, the heating and/or cooling device being capable of transferring heat energy from and/or to each of the drive system of the vehicle, the electrical energy storage device, the passenger compartment of the vehicle, and the external environment of the vehicle. Typically, the drive system is electric, and the electrical energy storage device comprises one or more electric batteries.

### BACKGROUND OF THE INVENTION

Said vehicles are provided with a computer to compute the desired temperature values of the different components and, after a computation to optimize the heat losses on a computed route, determine, at a time t:
the selection of an operating mode of the heating and/or cooling device from all of the possible modes,
a heating or cooling power level for the heating and/or cooling device.

### SUMMARY OF THE INVENTION

The invention aims in particular to reduce computation times.

To this end, one aspect of the invention relates to a thermal management method for a vehicle of the type comprising a drive system of the vehicle, an electrical energy storage device, and a heat pump heating and/or cooling device, to heat and/or cool the drive system of the vehicle, the electrical energy storage device, and the passenger compartment of the vehicle, the heating and/or cooling device being capable of transferring heat energy from and/or to each of the drive system of the vehicle, the electrical energy storage device, the passenger compartment of the vehicle, and the external environment of the vehicle, said thermal management method receiving at least the following as input:
an item of information about the route of the vehicle, the route being discretized into long sections and, for each long section, an item of information representing an average speed of the vehicle and an item of information representing an average road gradient,
an item of information representing an average drive power of the vehicle on each of said long route sections,
an item of information representing at least one meteorological condition on each of said long route sections,
an item of information representing at least one desired passenger compartment temperature on each of said long route sections,
said thermal management method comprising several computation sub-methods:
a computation sub-method for so-called long-term supervision on at least a plurality of said long sections, preferably on the entire route, which supervision sub-method:
   uses as input, for each of said long route sections: the information about the predicted average speeds, the predicted average road gradients, the predicted average drive powers of the vehicle, the at least one meteorological condition determined, and the at least one desired passenger compartment temperature,
   uses one thermal model wherein for each of said long route sections, the drive system of the vehicle, the electrical energy storage device, the passenger compartment of the vehicle, and the external environment of the vehicle are assigned an average temperature and a thermal capacity, and one thermal model wherein the heat energy can be transferred between them by the heating and/or cooling device,
   performs a simplified computation to optimize the heat losses of all of the devices on said plurality of long route sections, preferably on the entire route, which computation minimizes the sum of the heat losses of the electrical energy storage device, preferably only the heat losses of the electrical energy storage device,
   and supplies as output, for each of said plurality of long route sections:
      an item of information representing a target average temperature and/or average temperature variation value of the electrical energy storage device for each of said long sections,
      an item of information about the pre-selection of certain operating modes of the heating and/or cooling device from all of the possible modes,
      an item of information representing an average temperature of the drive system of the vehicle, of the electrical energy storage device, and of the passenger compartment of the vehicle, and
      an item of information representing a state of charge of the battery,
a computation sub-method for so-called short-term control on short route sections, shorter than said long sections, for example 10 times shorter:
   receives as input information representing the average drive power necessary on each of said short sections, and information representing an average speed of the vehicle and/or a speed variation of the vehicle on each of said short sections,
   uses one thermal model wherein for each of said short route sections, the drive system of the vehicle, the electrical energy storage device, the passenger compartment of the vehicle, and the external environment of the vehicle are assigned an item of information representing an average temperature and an item of information representing a thermal capacity, and one thermal model wherein the heat energy can be transferred between them by the heating and/or cooling device,
   performs a computation to optimize the heat losses on said plurality of short route sections, which computation minimizes the sum of the heat losses of the electrical energy storage device, the difference between the temperature of the electrical energy storage device and temperature setpoints of the electrical energy storage device, and the difference between the passenger compartment temperature and temperature setpoints of the passenger compartment, assigning a respective coefficient to each of these three optimization parameters,
   and supplies as output, for each of said short route sections:
      an item of information about the selection of a single operating mode of the heating and/or cooling device from all of the possible modes,
      an item of information about a heating or cooling power level for the heating and/or cooling device.

Such a method, due to its management of thermal optimization at two different model resolution levels, makes it possible to reduce the computation time.

The term “drive system” is used in a general manner and refers to front-wheel or rear-wheel drive of the vehicle.

According to particular embodiments, the method further comprises one or more of the following features, considered individually or in any technically possible combination:
the thermal management method further comprises a machine learning sub-method for correcting any discrepancies of the so-called supervision sub-method and/or of the so-called control sub-method and of their respective models with respect to measured values, so as to correct the models used,
the so-called supervision method is reiterated, for example if a difference has been found between measured temperature values of one or more of the temperatures of the electrical energy storage device, of the drive system of the vehicle, and of the passenger compartment, and the desired target values, this difference being for example greater than a respective predetermined value,
the lengths of said long sections are not all identical and/or the lengths of said short sections are not all identical, these lengths being computed for example in terms of distance travelled or travel time,
the thermal management method comprises a sub-method for controlling actuators of the heating and/or cooling device of the vehicle having as input the outputs of the so-called short-term control computation sub-method,
the thermal management method comprises a sub-method for computing the route of the vehicle, in particular as a function of traffic information, which discretizes the route into long sections and supplies, for each long section, said item of information representing an average speed of the vehicle and the item of information representing an average road gradient,
the thermal management method comprises a sub-method for computing power for the drive system of the vehicle, as a function of said information about the predicted average speeds on each of said long route sections and predicted average road gradients on each of said long route sections, which provides as output the information representing an average drive power of the vehicle on each of said long route sections,
the thermal management system comprises a sub-method for determining the information representing at least one meteorological condition on each of said long route sections,
the thermal management system comprises a sub-method for determining the information representing at least one desired passenger compartment temperature on each of said long route sections,
the thermal management system comprises a sub-method for computing the information representing the average drive power necessary on each of said short sections, and the information representing an average speed of the vehicle and/or a speed variation of the vehicle on each of said short sections.

Another aspect of the invention relates to a thermal management system for a vehicle, the vehicle being of the type comprising a drive system of the vehicle and an electrical energy storage device, the thermal management system comprising a heat pump heating and/or cooling device, configured to heat and/or cool the drive system of the vehicle, the electrical energy storage device, and the passenger compartment of the vehicle, the heating and/or cooling device being capable, after installation in the vehicle, of transferring heat energy from and/or to each of the drive system of the vehicle, the electrical energy storage device, the passenger compartment of the vehicle, and the external environment of the vehicle, said thermal management system comprising at least one memory and at least one computer, said at least one memory comprising computing instructions for implementing the thermal management method as described above at least partially on said at least one computer.

According to one particular embodiment, the thermal management system comprises at least one temperature sensor, the system being configured to measure, with the at least one temperature sensor, the temperature of one or more of the electrical energy storage device, the drive system of the vehicle, and the passenger compartment, and to transmit this temperature information to said at least one computer.

Another aspect of the invention relates to a vehicle comprising a drive system of the vehicle, an electrical energy storage device, and a thermal management system as described above.

According to particular embodiments, the vehicle further comprises one or more of the following features, considered individually or in any technically possible combination:
the drive system of the vehicle is at least partly electric, or even fully electric;
the vehicle is a motor vehicle.

### BRIEF DESCRIPTION OF DRAWINGS

FIG. 1 is a block diagram of the computation method implemented by the thermal management system of the vehicle.

### DETAILED DESCRIPTION OF THE INVENTION

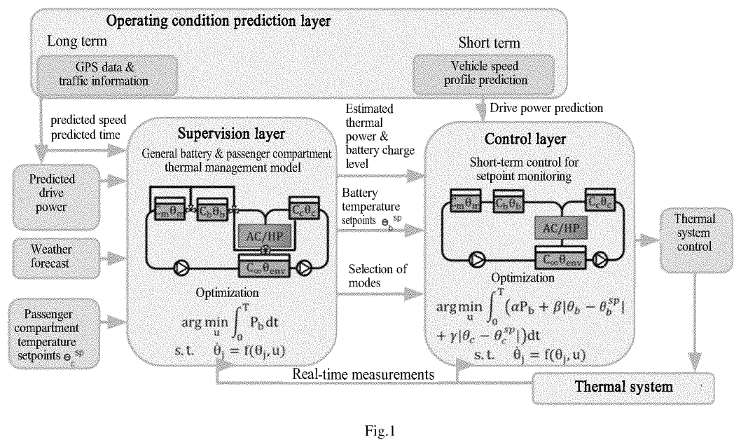

FIG. 1 is a block diagram of the computation method implemented by the thermal management system of the vehicle.

According to this illustrative example, the vehicle is an electric drive vehicle and comprises to this end a drive system of the vehicle, for example fully electric or hybrid. The vehicle further comprises an electrical energy storage device, i.e. an electric battery, to power the drive system of the vehicle, and the vehicle also comprises a thermal management system.

The vehicle is for example a motor vehicle, such as a car, a truck, a utility vehicle, etc.

The thermal management system of the vehicle comprises a heat pump heating and/or cooling device.

The thermal management system also comprises a computing portion comprising one or more memories in which computing commands are stored.

The heating and/or cooling device is configured to heat and/or cool the drive system of the vehicle, the electrical energy storage device, and the passenger compartment of the vehicle.

The heating and/or cooling device is capable, after installation in the vehicle, of transferring heat energy from and/or to each of the drive system of the vehicle, the electrical energy storage device, the passenger compartment of the vehicle, and the external environment of the vehicle.

In addition, the thermal management system comprises at least one temperature sensor for measuring, with the at least one temperature sensor, the temperature of one or more of the electrical energy storage device, the drive system of the vehicle, and the passenger compartment, and for transmitting this temperature information to said at least one computer.

As illustrated, the control system of the vehicle determines for example in the long term, a predicted speed and a predicted time as a function of the GPS and traffic data. The system deduces therefrom a predicted drive power at a given time, which forms an item of input data for the supervision layer, which uses a simplified thermal management model.

Other input data are for example the meteorological data and especially passenger compartment temperature setpoints. For example: 21° C. in the passenger compartment.

The supervision layer then deduces therefrom, for example, on different sections of the route, an estimated thermal load and battery level, and battery temperature setpoints, for example 31° on section 1, 32° C. on section 2, 31° C. again on section 3, etc., and the supervision layer also supplies as an output a selection of operating modes for the thermal management system.

This is then followed by short-term computing iterations on the different sections, by the control layer, which uses a more detailed thermal management model.

It will be noted that the control layer receives, through the general management system, necessary drive power values for each section.

The pre-selection of the operating modes greatly minimizes the computing time in the control layer. The control layer then determines the operating mode to be selected for implementation by the heating and/or cooling device. Each section is thus ultimately assigned a passenger compartment temperature target point, a battery temperature target point, and an operating mode of the heating and/or cooling device of the drive system of the vehicle, of the electrical energy storage device, and of the passenger compartment of the vehicle.

In addition, as can be seen in FIG. 1, real-time temperature measurement loops can be used to correct the input data.

What is claimed is:

1. A thermal management method for a vehicle with a drive system, an electrical energy storage device, and a heat pump heating and/or cooling device, to heat and/or cool the drive system of the vehicle, the electrical energy storage device, and the passenger compartment of the vehicle, the heating and/or cooling device being capable of transferring heat energy from and/or to each of the drive system of the vehicle, the electrical energy storage device, the passenger compartment of the vehicle, and the external environment of the vehicle, said thermal management method receiving at least the following as input:
an item of information about the route of the vehicle, the route being discretized into long sections and, for each long section, an item of information representing an average speed of the vehicle and an item of information representing an average road gradient,
an item of information representing an average drive power of the vehicle on each of said long route sections,
an item of information representing at least one meteorological condition on each of said long route sections,
an item of information representing at least one desired passenger compartment temperature on each of said long route sections,
said thermal management method comprising several computation sub-methods:
a computation sub-method for so-called long-term supervision on at least a plurality of said long sections, preferably on the entire route, which supervision sub-method:
uses as input, for each of said long route sections: the information about the predicted average speeds, the predicted average road gradients, the predicted average drive powers of the vehicle, the at least one meteorological condition determined, and the at least one desired passenger compartment temperature,
uses one thermal model wherein for each of said long route sections, the drive system of the vehicle, the electrical energy storage device, the passenger compartment of the vehicle, and the external environment of the vehicle are assigned an average temperature and a thermal capacity, and one thermal model wherein the heat energy can be transferred between them by the heating and/or cooling device,
performs a simplified computation to optimize the heat losses of all of the devices on said plurality of long route sections, preferably on the entire route, which computation minimizes the sum of the heat losses of the electrical energy storage device, preferably only the heat losses of the electrical energy storage device,
and supplies as output, for each of said plurality of long route sections:
an item of information representing a target average temperature and/or average temperature variation value of the electrical energy storage device for each of said long sections,
an item of information about the pre-selection of certain operating modes of the heating and/or cooling device from all of the possible modes,
an item of information representing an average temperature of the drive system of the vehicle, of the electrical energy storage device, and of the passenger compartment of the vehicle, and
an item of information representing a state of charge of the battery,
a computation sub-method for so-called short-term control on short route sections, shorter than said long sections, for example 10 times shorter:
receives as input information representing the average drive power necessary on each of said short sections, and information representing an average speed of the vehicle and/or a speed variation of the vehicle on each of said short sections,
uses one thermal model wherein for each of said short route sections, the drive system of the vehicle, the electrical energy storage device, the passenger compartment of the vehicle, and the external environment of the vehicle are assigned an item of information representing an average temperature and an item of information representing a thermal capacity, and one thermal model wherein the heat energy can be transferred between them by the heating and/or cooling device,
performs a computation to optimize the heat losses on said plurality of short route sections, which computation minimizes the sum of the heat losses of the electrical energy storage device, the difference between the temperature of the electrical energy storage device and temperature setpoints of the electrical energy storage device, and the difference between the passenger compartment temperature and temperature setpoints of the passenger compartment, assigning a respective coefficient to each of these three optimization parameters,
and supplies as output, for each of said short route sections:
an item of information about the selection of a single operating mode of the heating and/or cooling device from all of the possible modes,
an item of information about a heating or cooling power level for the heating and/or cooling device.

2. The thermal management method as claimed in claim 1, further comprising a machine learning sub-method for correcting any discrepancies of the so-called supervision sub-method and/or of the so-called control sub-method and of their respective models with respect to measured values, so as to correct the models used.

3. The thermal management method as claimed in claim 1, wherein the so-called supervision method is reiterated, for example if a difference has been found between measured temperature values of one or more of the temperatures of the electrical energy storage device, of the drive system of the vehicle, and of the passenger compartment, and the desired target values, this difference being for example greater than a respective predetermined value.

4. The thermal management method as claimed in claim 1, wherein the lengths of said long sections are not all identical and/or the lengths of said short sections are not all identical, these lengths being computed for example in terms of distance travelled or travel time.

5. The thermal management method as claimed in claim 1, further comprising a sub-method for controlling actuators of the heating and/or cooling device of the vehicle having as input the outputs of the so-called short-term control computation sub-method.

6. A thermal management system for a vehicle with a drive system and an electrical energy storage device, the thermal management system comprising a heat pump heating and/or cooling device, configured to heat and/or cool the drive system of the vehicle, the electrical energy storage device, and the passenger compartment of the vehicle, the heating and/or cooling device being capable, after installation in the vehicle, of transferring heat energy from and/or to each of the drive system of the vehicle, the electrical energy storage device, the passenger compartment of the vehicle, and the external environment of the vehicle, said thermal management system further comprising at least one memory and at least one computer, said at least one memory including computing instructions for implementing a thermal management method on said at least one computer, the thermal management method receiving at least the following as input:
an item of information about the route of the vehicle, the route being discretized into long sections and, for each long section, an item of information representing an average speed of the vehicle and an item of information representing an average road gradient,
an item of information representing an average drive power of the vehicle on each of said long route sections,
an item of information representing at least one meteorological condition on each of said long route sections,
an item of information representing at least one desired passenger compartment temperature on each of said long route sections,
said thermal management method including several computation sub-methods:
a computation sub-method for so-called long-term supervision on at least a plurality of said long sections, preferably on the entire route, which supervision sub-method:
uses as input, for each of said long route sections: the information about the predicted average speeds, the predicted average road gradients, the predicted average drive powers of the vehicle, the at least one meteorological condition determined, and the at least one desired passenger compartment temperature,
uses one thermal model wherein for each of said long route sections, the drive system of the vehicle, the electrical energy storage device, the passenger compartment of the vehicle, and the external environment of the vehicle are assigned an average temperature and a thermal capacity, and one thermal model wherein the heat energy can be transferred between them by the heating and/or cooling device,
performs a simplified computation to optimize the heat losses of all of the devices on said plurality of long route sections, preferably on the entire route, which computation minimizes the sum of the heat losses of the electrical energy storage device, preferably only the heat losses of the electrical energy storage device,
and supplies as output, for each of said plurality of long route sections:
an item of information representing a target average temperature and/or average temperature variation value of the electrical energy storage device for each of said long sections,
an item of information about the pre-selection of certain operating modes of the heating and/or cooling device from all of the possible modes,
an item of information representing an average temperature of the drive system of the vehicle, of the electrical energy storage device, and of the passenger compartment of the vehicle, and
an item of information representing a state of charge of the battery,
a computation sub-method for so-called short-term control on short route sections, shorter than said long sections, for example 10 times shorter:
receives as input information representing the average drive power necessary on each of said short sections, and information representing an average speed of the vehicle and/or a speed variation of the vehicle on each of said short sections,
uses one thermal model wherein for each of said short route sections, the drive system of the vehicle, the electrical energy storage device, the passenger compartment of the vehicle, and the external environment of the vehicle are assigned an item of information representing an average temperature and an item of information representing a thermal capacity, and one thermal model wherein the heat energy can be transferred between them by the heating and/or cooling device,
performs a computation to optimize the heat losses on said plurality of short route sections, which computation minimizes the sum of the heat losses of the electrical energy storage device, the difference between the temperature of the electrical energy storage device and temperature setpoints of the electrical energy storage device, and the difference between the passenger compartment temperature and temperature setpoints of the passenger compartment, assigning a respective coefficient to each of these three optimization parameters,
and supplies as output, for each of said short route sections:
an item of information about the selection of a single operating mode of the heating and/or cooling device from all of the possible modes,
an item of information about a heating or cooling power level for the heating and/or cooling device.

7. The thermal management system as claimed in claim 6, further comprising at least one temperature sensor, the system being configured to measure, with the at least one temperature sensor, the temperature of one or more of the electrical energy storage device, the drive system of the vehicle, and the passenger compartment, and to transmit this temperature information to said at least one computer.

8. A vehicle comprising a drive system, an electrical energy storage device, and a thermal management system including a heat pump heating and/or cooling device, configured to heat and/or cool the drive system of the vehicle, the electrical energy storage device, and the passenger compartment of the vehicle, the heating and/or cooling device being capable, after installation in the vehicle, of transferring heat energy from and/or to each of the drive system of the vehicle, the electrical energy storage device, the passenger compartment of the vehicle, and the external environment of the vehicle, said thermal management system including at least one memory and at least one computer, said at least one memory including computing instructions for implementing a thermal management method on said at least one computer, the thermal management method receiving at least the following as input:
an item of information about the route of the vehicle, the route being discretized into long sections and, for each long section, an item of information representing an average speed of the vehicle and an item of information representing an average road gradient,
an item of information representing an average drive power of the vehicle on each of said long route sections,
an item of information representing at least one meteorological condition on each of said long route sections,
an item of information representing at least one desired passenger compartment temperature on each of said long route sections,
said thermal management method including several computation sub-methods:
a computation sub-method for so-called long-term supervision on at least a plurality of said long sections, preferably on the entire route, which supervision sub-method:
uses as input, for each of said long route sections: the information about the predicted average speeds, the predicted average road gradients, the predicted average drive powers of the vehicle, the at least one meteorological condition determined, and the at least one desired passenger compartment temperature,
uses one thermal model wherein for each of said long route sections, the drive system of the vehicle, the electrical energy storage device, the passenger compartment of the vehicle, and the external environment of the vehicle are assigned an average temperature and a thermal capacity, and one thermal model wherein the heat energy can be transferred between them by the heating and/or cooling device,
performs a simplified computation to optimize the heat losses of all of the devices on said plurality of long route sections, preferably on the entire route, which computation minimizes the sum of the heat losses of the electrical energy storage device, preferably only the heat losses of the electrical energy storage device,
and supplies as output, for each of said plurality of long route sections:
an item of information representing a target average temperature and/or average temperature variation value of the electrical energy storage device for each of said long sections,
an item of information about the pre-selection of certain operating modes of the heating and/or cooling device from all of the possible modes,
an item of information representing an average temperature of the drive system of the vehicle, of the electrical energy storage device, and of the passenger compartment of the vehicle, and
an item of information representing a state of charge of the battery,
a computation sub-method for so-called short-term control on short route sections, shorter than said long sections, for example 10 times shorter:
receives as input information representing the average drive power necessary on each of said short sections, and information representing an average speed of the vehicle and/or a speed variation of the vehicle on each of said short sections,
uses one thermal model wherein for each of said short route sections, the drive system of the vehicle, the electrical energy storage device, the passenger compartment of the vehicle, and the external environment of the vehicle are assigned an item of information representing an average temperature and an item of information representing a thermal capacity, and one thermal model wherein the heat energy can be transferred between them by the heating and/or cooling device,
performs a computation to optimize the heat losses on said plurality of short route sections, which computation minimizes the sum of the heat losses of the electrical energy storage device, the difference between the temperature of the electrical energy storage device and temperature setpoints of the electrical energy storage device, and the difference between the passenger compartment temperature and temperature setpoints of the passenger compartment, assigning a respective coefficient to each of these three optimization parameters,
and supplies as output, for each of said short route sections:
an item of information about the selection of a single operating mode of the heating and/or cooling device from all of the possible modes,
an item of information about a heating or cooling power level for the heating and/or cooling device.

9. The vehicle as claimed in claim 8, the drive system being at least partly electric, or fully electric.

10. The vehicle as claimed in claim 9, the vehicle being a motor vehicle.
